(19) United States
(12) Patent Application Publication
(10) Pub. No.: US 2025/0262130 A1
(43) Pub. Date: Aug. 21, 2025

(54) Chewing aid for baby

(71) Applicant: Cottage Flooring Ltd, Loughton (GB)

(72) Inventor: Joseph Anthony Bergamini, Loughton (GB)

(21) Appl. No.: 19/058,767

(22) Filed: Feb. 20, 2025

(30) Foreign Application Priority Data
Feb. 20, 2024 (GB) 2402404.4

(51) Int. Cl. A61J 17/02; A61J 17/00

(52) U.S. Cl. CPC A61J 17/02; A61J 17/1111

(57) ABSTRACT

A teething tube formed from a resilient material wherein the teething tube has a clip suitable for attaching the tube to a sheet of fabric; and a teething kit comprising the teething tube and a fabric sheet.

The present invention relates to a teething tube.

When babies are from 3 to 7 months old, they will start growing their first teeth. As a result, they start to drool more and to gnaw on objects to help alleviate the pressure on their gums. Typically, a parent might give their baby a rubber teething ring to aid the teething process. A teething ring is easy for babies to use when they are seated or lying down as they can grasp it with both hands, but they will usually drop it if they are using it when they are being carried, for example, when they are being comforted.

A way of ameliorating these problems has been sought.

According to the invention there is provided a teething tube formed from a resilient material wherein the teething tube has a clip suitable for attaching the tube to a sheet of fabric.

According to the invention there is provided a teething tube which consists of a teething tube body at its proximal end and a clip at its distal end suitable for attaching the tube to a sheet of fabric wherein the teething tube body is formed from a resilient material.

According to the invention there is also provided a teething kit comprising the teething tube according to the invention and a sheet of fabric.

Advantages of the invention include that a problem identified by the inventor that when a teething baby is being carried, the baby will typically gnaw and drool on the carrier's shoulder. As a result, the person carrying the baby needs to change their top and will have a sore shoulder. The teething tube solves this problem as the sheet of fabric absorbs the drool and the baby can chew the teething tube, avoiding harm to that person.

In some embodiments, the teething tube may form a teething tube body. In some embodiments, the teething tube may form a teething tube body at its proximal end. In some embodiments, the teething tube body may have a polygonal, flattened circular, or flattened oval cross-section. In some embodiments, the polygonal cross-section may have from three to eight sides, e.g. from three to six sides, e.g. three or four sides. In some embodiments, the teething tube body may be hollow. In some embodiments, the teething tube may be formed from a plastic material. In some embodiments, the teething tube may have a rubber outer layer or coating.

In some embodiments, the clip may comprise two legs. In some embodiments, the legs of the clip may be parallel legs or may be hinged together and their distal ends may be urged together. In some embodiments, the clip may comprise a spring at its proximal end to urge (or bias) the distal ends of the clip legs together such that the clip is normally closed. In some embodiments, the teething tube body may be hollow and formed from a compressible material such that the proximal ends of the legs may be manipulated, e.g. by squeezing the hollow teething tube body.

In some embodiments, the clip legs may comprise an upper clip leg and a lower clip leg. In some embodiments, the clip legs may comprise an upper clip leg and a lower clip leg where the clip legs are parallel clip legs. In some embodiments, where the clip legs are parallel legs, the clip legs (e.g. the upper and lower clip legs) are separated by a horizontal clip slot. In some embodiments, the clip slot may have a rectilinear cross-section, e.g. a rectangular cross-section. In some embodiments, the lower clip leg may have a rectilinear or trapezial cross-section, e.g. a rectangular or trapezoidal cross-section. In some embodiments, the lower clip leg may form a flat lower surface to act as a base for the teething tube.

In some embodiments, the upper clip leg and/or lower clip leg may taper at its distal end. An advantage of such tapered upper and/or lower clip legs is that the clip slot widens at its distal end to case insertion of a fabric sheet into the clip. In some embodiments, the upper clip leg may have a polygonal, flattened circular, or flattened oval cross-section. In some embodiments, the upper clip leg may have a flat base.

In some embodiments, the teething tube may have a cute shape to be attractive to a baby. For example, the teething tube may be shaped like an animal (such as a cat, dog, caterpillar), fish, fruit, and/or flower. In some embodiments, the teething tube body may form a cute teething tube body. In some embodiments, the upper clip leg may form a cute upper clip leg.

In some embodiments, the fabric sheet may be formed from an absorbent material. In some embodiments, the fabric sheet may be formed from a natural material such as cotton. In some embodiments, the fabric sheet may be muslin cloth.

The invention will now be illustrated with reference to the following Figures of the accompanying drawings which are not intended to limit the scope of the claimed invention:

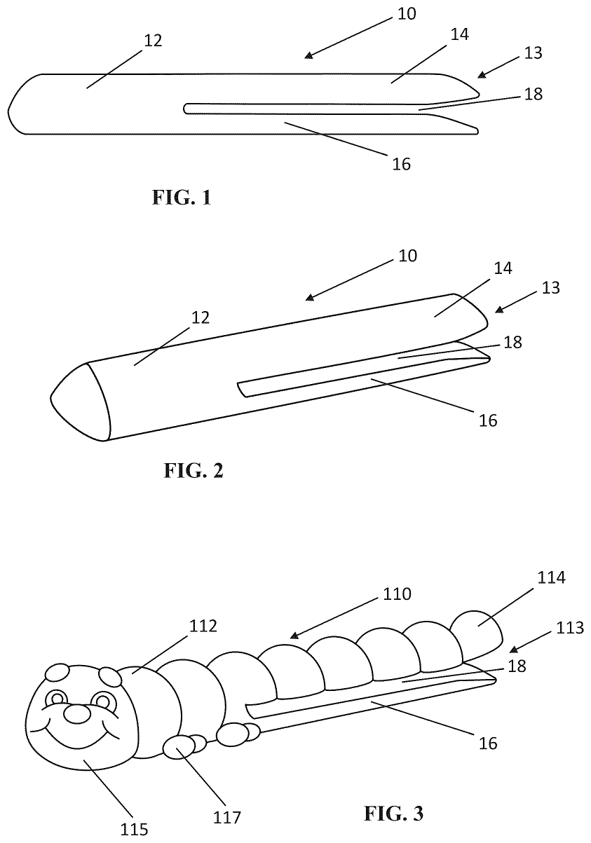

FIG. 1 shows a schematic side view of a first embodiment of the teething tube according to the invention;

FIG. 2 shows a schematic perspective view of the first embodiment of the teething tube according to the invention;

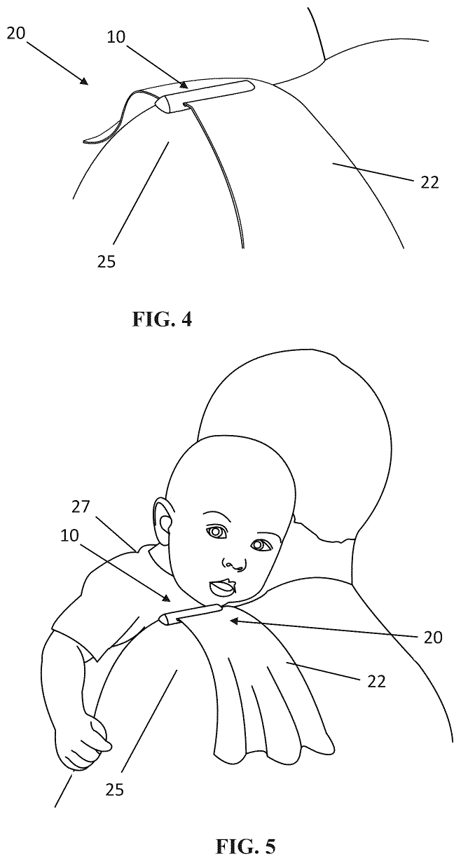

FIG. 3 shows a schematic perspective view of a second embodiment of the teething tube according to the invention;

FIG. 4 shows a schematic perspective view of a teething kit according to the invention in use on a person's shoulder; and

FIG. 5 shows a schematic perspective view of the teething kit according to the invention in use on a person's shoulder with a baby.

A first embodiment of a teething tube according to the invention is indicated generally at 10 on FIGS. 1 and 2. Teething tube 10 has a triangular cross-section. At its proximal end, teething tube 10 forms a teething tube body 12.

At its distal end, teething tube 10 forms a clip indicated generally at 13. Clip 13 comprises an upper clip leg 14 and a lower clip leg 16 which are separated by a horizontal slot 18. Upper clip leg 14 and a lower clip leg 16 are arranged to be parallel. Slot 18 has a rectangular cross-sectional shape. Lower clip leg 16 has a rectangular cross-section such that it forms a flat lower surface to act as a base for the teething tube 10. In an alternative embodiment, the upper clip leg 14 and the lower clip leg 16 may be hinged together and the clip may have a spring at its proximal end to urge the distal ends of the upper clip leg 14 and the lower clip leg 16.

Lower clip leg 16 tapers at its distal end such that slot 18 widens at its distal end to ease insertion of a fabric sheet into the clip 13. Upper clip leg 14 has a triangular cross-section having a flat base. Upper clip leg 14 tapers at its distal end such that slot 18 widens at its distal end to ease insertion of a fabric sheet into the clip 13 and such that the teething tube 10 presents rounded surfaces.

A second embodiment of a teething tube according to the invention is indicated generally at 110 on FIG. 3. Teething tube 110 has a flattened circular cross-section such that it forms a flat lower surface to act as a base. Teething tube 110 forms the shape of a caterpillar which is a cute shape designed to be attractive to a baby.

At its proximal end, teething tube 110 forms a teething tube body 112. Teething tube body 112 forms a series of linked spherical objects to give the appearance of a cute caterpillar body. At the proximal end of teething tube body 112, a cute shape facial feature 115 is formed. On the lower surface of the teething body 112, cute shape features 117 are formed in the shape of caterpillar feet.

At its distal end, teething tube 110 forms a clip indicated generally at 113. Clip 113 comprises an upper clip leg 114 and a lower clip leg 16 which are separated by a horizontal slot 18. Slot 18 has a rectangular cross-sectional shape. Lower clip leg 16 has a rectangular cross-section. Lower clip leg 16 tapers at its distal end such that slot 18 widens at its distal end to ease insertion of a fabric sheet into the clip 13.

Upper clip leg 114 has a flattened circular cross-section. Upper clip leg 114 forms a series of linked spherical objects to give the appearance of a cute caterpillar body. Upper clip leg 114 tapers at its distal end such that slot 18 widens at its distal end to ease insertion of a fabric sheet into the clip 113.

A teething kit according to the invention is indicated generally at 20 on FIGS. 4 and 5. Teething kit 20 is shown on FIGS. 4 and 5 as comprising the teething tube 10 according to the first embodiment of the invention and a fabric sheet 22. Teething kit 20 is shown in use where the fabric sheet is arranged over a person's shoulder 25 such that one end of the fabric sheet 22 rests on the person's chest and the other end of the sheet 22 rests on the person's back. The fabric sheet 22 is inserted into the slot 18 of the teething tube 10. The teething tube 10 is arranged on top of the shoulder 25 such that it is easily accessible to a baby 27. The baby 27 then chews on the teething tube 10 and its drool is soaked up by the fabric sheet. The person carrying the baby 27 may use the fabric sheet 22 to wipe any drool off the baby's face.

What is claimed is:

1. A teething tube formed from a resilient material wherein the teething tube has a clip suitable for attaching the tube to a sheet of fabric.

2. A teething tube as defined in claim 1 which forms a teething tube body.

3. A teething tube as defined in claim 2 wherein the teething tube forms a teething tube body at its proximal end.

4. A teething tube as defined in claim 2 wherein the teething tube body has a polygonal, flattened circular, or flattened oval cross-section.

5. A teething tube as defined in claim 4 wherein the polygonal cross-section has from three to eight sides.

6. A teething tube as defined in claim 2 wherein the teething tube body is hollow.

7. A teething tube as defined in claim 1 which is formed from a plastic material.

8. A teething tube as defined in claim 1 wherein the teething tube has a rubber outer layer or coating.

9. A teething tube as defined in claim 1 wherein the clip comprises two clip legs.

10. A teething tube as defined in claim 9 wherein the legs of the clip are parallel legs.

11. A teething tube as defined in claim 9 wherein the clip legs are separated by a horizontal clip slot.

12. A teething tube as defined in claim 11 wherein the clip slot has a rectilinear cross-section.

13. A teething tube as defined in claim 10 wherein the legs of the clip are hinged together and their distal ends are urged together.

14. A teething tube as defined in claim 13 wherein the clip comprises a spring at its proximal end to bias the distal ends of the clip legs together.

15. A teething tube as defined in claim 14 wherein the teething tube body is hollow and formed from a compressible material such that the proximal ends of the legs may be manipulated.

16. A teething tube as defined in claim 9 wherein the clip legs comprise an upper clip leg and a lower clip leg wherein the upper clip leg has a polygonal, flattened circular, or flattened oval cross-section.

17. A teething tube as defined in claim 1 wherein the teething tube has a cute shape to be attractive to a baby.

18. A teething tube as defined in claim 1 which consists of a teething tube body at its proximal end and a clip at its distal end suitable for attaching the tube to a sheet of fabric wherein the teething tube body is formed from a resilient material.

19. A teething kit comprising the teething tube as defined in claim 1 and a sheet of fabric.

20. A teething kit as defined in claim 18 wherein the fabric sheet is formed from an absorbent material.
